(19) United States
(12) Patent Application Publication
(10) Pub. No.: US 2026/0221476 A1
(43) Pub. Date: Jul. 30, 2026

(54) ENVIRONMENT SENSOR AND ENVIRONMENT POWER GENERATION DEVICE

(71) Applicants: ABLIC Inc., Nagano (JP); Tokyo University of Science Foundation, Tokyo (JP)

(72) Inventors: Fumiyasu UTSUNOMIYA, Nagano (JP); Yusuke TAKEUCHI, Nagano (JP); Norihiro OKAZAKI, Nagano (JP); Isao SHITANDA, Tokyo (JP); Takeru SAMORI, Tokyo (JP); Momo CHIBA, Tokyo (JP)

(73) Assignees: ABLIC Inc., Nagano (JP); Tokyo University of Science Foundation, Tokyo (JP)

(21) Appl. No.: 19/455,743

(22) Filed: Jan. 21, 2026

(30) Foreign Application Priority Data
Jan. 27, 2025 (JP) 2025-011531

(51) Int. Cl. H01M 8/04537; H01M 4/96; H01M 8/04858; H01M 4/86

(52) U.S. Cl. CPC H01M 8/04574; H01M 4/96; H01M 8/04544; H01M 8/04865; H01M 2004/8684; H01M 2004/8689

(57) ABSTRACT

Provided are an environment sensor and an environment power generation device capable of measuring generated power of a power generation element to follow a changing environment. The environment sensor includes a voltage control circuit and a current measurement circuit. The voltage control circuit includes a voltage control terminal configured to receive a generated current and a current output terminal configured to provide an output current, and is configured to receive the generated current at the voltage control terminal while controlling a voltage of a positive electrode terminal of the power generation element connected to the voltage control terminal to a first predetermined voltage lower than a generated voltage of the power generation element. The current measurement circuit includes a current measurement terminal configured to receive the output current and a signal output terminal configured to provide a measurement signal.

### CROSS-REFERENCE TO RELATED APPLICATION

This application claims the priority benefit of Japan application serial no. 2025-011531, filed on January 27, 2025. The entirety of the above-mentioned patent application is hereby incorporated by reference herein and made a part of this specification.

### BACKGROUND

### 1. Field

The present invention relates to an environment sensor and an environment power generation device.

### 2. Description of the Related Art

An environment in which a power generation element is placed can be sensed through measurement of generated power of a power generation element for generating electric power that changes depending on the environment. For example, measuring the generated power of a fuel cell in an environment in which fuel is supplied to the fuel cell allows sensing of a concentration of the supplied fuel. A related-art method of measuring the generated power of the fuel cell includes measuring a power generation characteristic of the fuel cell by connecting a constant current load to an output terminal of the fuel cell to measure an amount of change in an output voltage of the fuel cell before and after connecting the constant current load (see, for example, Japanese Patent Application Laid-open No. 2009-117110).

However, a related-art power generation element, such as a fuel cell, has a parasitic capacitance therein. Because of this, it takes a very long time until a drop voltage value corresponding to the power generation characteristic is reached. Accordingly, even when the environment such as the fuel concentration changes, the change in the environment such as the fuel concentration is not detectable until the drop voltage reaches the drop voltage value corresponding to the generated power. The environment such as the fuel concentration is thus not accurately measurable. In short, the related-art measurement technology for the power generation characteristic of the power generation element, such as the fuel cell, is not able to accurately measure the environment, such as the fuel concentration, which changes moment by moment.

### SUMMARY

An object of the present invention is to provide an environment sensor and an environment power generation device that are capable of measuring generated power of a power generation element, such as a fuel cell, so as to follow an environment, such as a fuel concentration, which changes moment by moment.

An environment sensor according to at least one aspect of the present invention includes: a voltage control circuit including a voltage control terminal configured to receive a generated current generated by a power generation element and a current output terminal configured to provide an output current corresponding to the generated current, the voltage control circuit being configured to receive the generated current at the voltage control terminal while controlling a voltage of a positive electrode terminal of the power generation element connected to the voltage control terminal to a first predetermined voltage lower than a generated voltage of the power generation element; and a current measurement circuit including a current measurement terminal configured to receive the output current provided from the voltage control circuit and a signal output terminal configured to provide a measurement signal corresponding to the output current received at the current measurement terminal.

An environment power generation device according to at least one aspect of the present invention includes: a power generation element; a voltage control circuit including a voltage control terminal configured to receive a generated current generated by the power generation element and a current output terminal configured to provide an output current corresponding to the generated current, the voltage control circuit being configured to receive the generated current at the voltage control terminal while controlling a voltage of a positive electrode terminal of the power generation element connected to the voltage control terminal to a first predetermined voltage lower than a generated voltage of the power generation element; and a current measurement circuit including a current measurement terminal configured to receive the output current provided from the voltage control circuit and a signal output terminal configured to provide a measurement signal corresponding to the output current received at the current measurement terminal.

According to the at least aspect of the present invention, it is possible to measure the generated power of the power generation element, such as the fuel cell, so as to follow the environment that changes moment by moment.

### BRIEF DESCRIPTION OF THE DRAWINGS

FIG. 1 is a diagram for illustrating an overall configuration example of an environment power generation device according to at least one embodiment of the present invention.

FIG. 2 is a diagram for illustrating a configuration example of a power generation element in the environment power generation device according to the at least one embodiment.

FIG. 3 is a diagram for illustrating a first configuration example of a voltage control circuit in an environment sensor according to the at least one embodiment.

FIG. 4 is a diagram for illustrating a first configuration example of a current measurement circuit in the environment sensor according to the at least one embodiment.

FIG. 5 is a diagram for illustrating a second configuration example of the voltage control circuit in the environment sensor according to the at least one embodiment.

FIG. 6 is a diagram for illustrating a second configuration example of the current measurement circuit in the environment sensor according to the at least one embodiment.

### DESCRIPTION OF THE EMBODIMENTS

Now, an environment sensor and an environment power generation device according to at least one embodiment of the present invention are described with reference to the drawings. The environment power generation device according to the at least one embodiment includes an environment sensor according to the at least one embodiment and a power generation element for suppling generated power generated in the environment sensor.

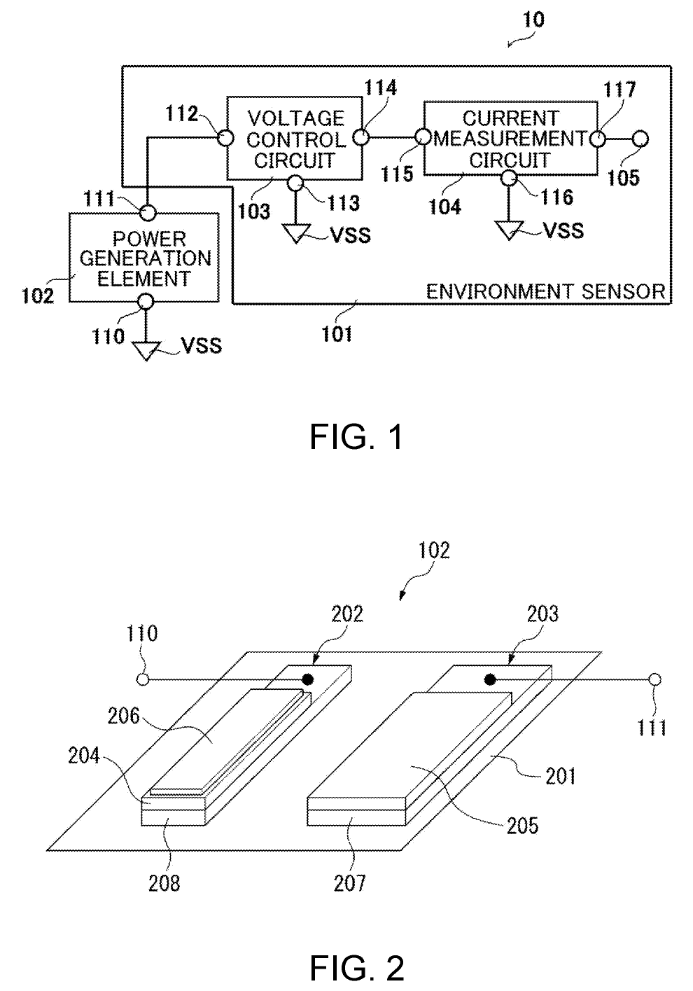

FIG. 1 is a diagram for illustrating an overall configuration example of an environment power generation device 10 which is an example of the environment power generation device according to the at least one embodiment.

The environment power generation device 10 includes an environment sensor 101 and a power generation element 102.

The environment sensor 101 includes a voltage control circuit 103 and a current measurement circuit 104. The power generation element 102 includes a reference terminal 110 and a positive electrode terminal 111. The reference terminal 110 is connected to a VSS terminal for supplying a predetermined power supply voltage (hereinafter referred to as "common ground voltage") which is a reference potential in the environment power generation device 10. In the at least one embodiment, a case in which the common ground voltage is 0 V is described as an example.

The voltage control circuit 103 includes a voltage control terminal 112 corresponding to an input terminal of the environment sensor 101, a reference terminal 113, and a current output terminal 114. The current measurement circuit 104 includes a current measurement terminal 115, a reference terminal 116, and a signal output terminal 117. The signal output terminal 117 is connected to an output terminal 105 of the environment sensor 101 and the environment power generation device 10. The reference terminal 110, the reference terminal 113, and the reference terminal 116 are each connected to the VSS terminal.

Next, the operation and effects of the environment power generation device 10 including: the environment sensor 101 including the voltage control circuit 103 and the current measurement circuit 104; and the power generation element 102 are described.

The voltage control circuit 103 receives a generated current that is a current generated by the power generation element 102 at the voltage control terminal 112 while controlling the voltage of the positive electrode terminal 111 of the power generation element 102 connected to the voltage control terminal 112 to a first predetermined voltage. The first predetermined voltage is a predetermined voltage lower than a generated voltage of the power generation element 102. The first predetermined voltage is set in advance in accordance with the type of the power generation element 102. The voltage control circuit 103 provides an output current that is a current corresponding to the generated current of the power generation element 102 from the current output terminal 114.

The current measurement circuit 104 receives the output current of the voltage control circuit 103 provided from the current output terminal 114, at the current measurement terminal 115. The current measurement circuit 104 provides a measurement signal corresponding to the current received at the current measurement terminal 115 from the signal output terminal 117. The measurement signal provided from the signal output terminal 117 is provided from the output terminal 105. The measurement signal provided from the output terminal 105 is read by an external device (not shown).

The external device analyzes the environment in which the power generation element 102 is placed through use of the read measurement signal. For example, in a case in which a fuel cell is used as the power generation element 102, the measurement signal is converted into a fuel concentration. For this conversion, for example, information indicating a relationship between the measurement signal and the fuel concentration, such as a predetermined relational expression or table indicating the relationship between the measurement signal and the fuel concentration, is used.

The environment sensor 101 can control the voltage of the positive electrode terminal 111 of the power generation element 102 connected to the voltage control terminal 112 to the first predetermined voltage. Accordingly, there is no need to wait until the voltage of the positive electrode terminal 111 reaches a drop voltage value corresponding to the power generation characteristic, unlike the related art. Because of this, the environment sensor 101 can measure the power generation characteristic so as to follow the environment that changes moment by moment.

FIG. 2 is a diagram for illustrating a schematic configuration of a biofuel cell serving as a configuration example of the power generation element 102 in the environment power generation device 10.

The biofuel cell which is the power generation element 102 is configured such that a reaction due to the diffusion of fuel is the slowest among a series of power generation reactions. As illustrated in FIG. 2 as an example, the biofuel cell includes a negative electrode 202 and a positive electrode 203 on a substrate 201 such as paper.

The negative electrode 202 includes an enzyme 204 which reacts with fuel, a mediator 206, and a main body portion 208 which is a conductor. The enzyme 204 and the mediator 206 are stacked on the main body portion 208 in the stated order from a side closer to the main body portion 208. The main body portion 208 is connected to the reference terminal 110. In the negative electrode 202, the power generation reaction is promoted by the mediator 206. The mediator 206 is an oxidation-reduction compound which mediates the transfer of electrons between the main body portion 208 and the enzyme 204.

The positive electrode 203 includes an enzyme 205 which reacts with oxygen and a main body portion 207 which is a conductor. In the positive electrode 203, the main body portion 207 is connected to the positive electrode terminal 111. The area of the positive electrode 203 is larger than the area of the negative electrode 202 in order to promote the reaction with oxygen. That is, an area in which the enzyme 205 and the main body portion 207 in the positive electrode 203 are in contact with each other is formed to be larger than an area in which the enzyme 204 and the main body portion 208 in the negative electrode 202 are in contact with each other.

As described above, the biofuel cell includes the mediator 206 to promote the power generation reaction at the negative electrode 202. Further, in the biofuel cell, the area of the positive electrode 203 is formed to be larger than the area of the negative electrode 202 in order to promote the reaction with oxygen. With the biofuel cell which is an example of the power generation element 102 having the above-mentioned configuration, the reaction speed at the positive electrode 203 and the reaction speed at the negative electrode 202 can be increased during power generation.

By increasing the reaction speed at at least one of the negative electrode 202 or the positive electrode 203, the reaction due to the diffusion of the supplied fuel becomes slower as compared to before the reaction speed at the electrode is increased, among the series of power generation reactions due to the fuel. With the reaction due to the diffusion of the fuel being relatively slower, the change in the power generation characteristic with respect to the change in the fuel concentration becomes relatively larger. In other words, by increasing the reaction speed at at least one of the negative electrode 202 or the positive electrode 203, a change in the power generation characteristic caused by a slow reaction speed at the negative electrode 202 or the positive electrode 203 can be suppressed. Because of this, the environment power generation device 10 can accurately measure the fuel concentration by measuring the generated power of the power generation element 102 configured as described above.

With the reaction due to the diffusion of the fuel being made slower as compared to the reaction at the electrode as described above, the reaction due to the diffusion of the fuel becomes the slowest reaction among the series of power generation reactions due to the fuel.

Next, the voltage control circuit 103 and the current measurement circuit 104 are each described.

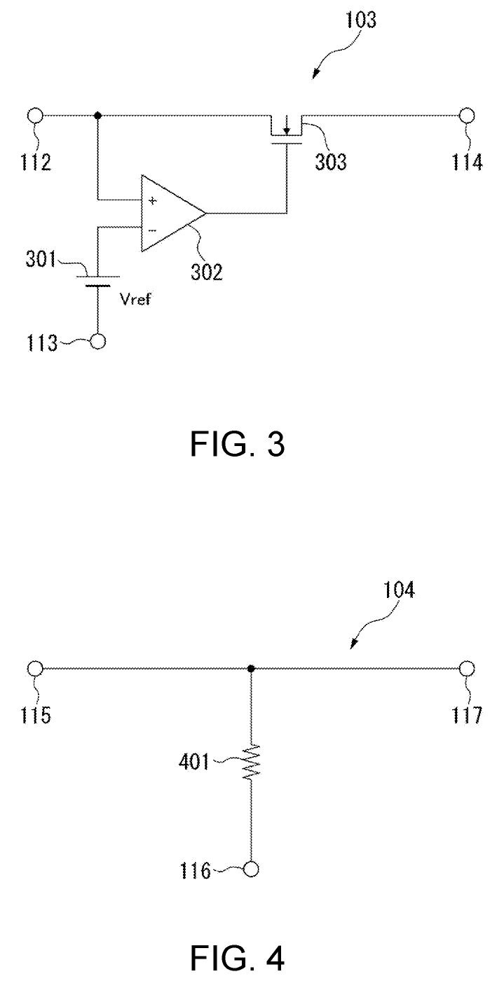

FIG. 3 is a diagram for illustrating the voltage control circuit 103 which is a first configuration example of the voltage control circuit in the environment sensor according to the at least one embodiment.

The voltage control circuit 103 includes a reference voltage circuit 301, an amplifier circuit 302, an N-channel MOS transistor (hereinafter referred to as "NMOS transistor") 303, the voltage control terminal 112, the reference terminal 113, and the current output terminal 114.

The reference voltage circuit 301 includes a first terminal and a second terminal for generating a voltage that is higher by a reference voltage Vref than the voltage of the first terminal. The first terminal is connected to the reference terminal 113. Accordingly, the reference voltage circuit 301 supplies a voltage that is higher by the reference voltage Vref than the voltage of the reference terminal 113 that is the same node as the first terminal, from the second terminal to the amplifier circuit 302.

The amplifier circuit 302 includes a non-inverting input terminal (+) connected to the voltage control terminal 112 and an inverting input terminal (-) connected to the second terminal of the reference voltage circuit 301. The voltage of the voltage control terminal 112 is received at the non-inverting input terminal (+). The reference voltage Vref is supplied from the second terminal of the reference voltage circuit 301 to the inverting input terminal (-).

In the NMOS transistor 303, a gate is connected to an output terminal of the amplifier circuit 302, a drain is connected to the voltage control terminal 112, and a source is connected to the current output terminal 114.

The amplifier circuit 302 controls the gate voltage of the NMOS transistor 303 so that the voltage of the voltage control terminal 112 received at the non-inverting input terminal (+) and the reference voltage Vref supplied to the inverting input terminal (-) become the same voltage value. Because of this, the generated current received at the voltage control terminal 112 is provided from the current output terminal 114 as the output current, under a state in which the voltage of the voltage control terminal 112 is controlled at the reference voltage Vref.

FIG. 4 is a diagram for illustrating the current measurement circuit 104 which is a first configuration example of the current measurement circuit in the environment sensor according to the at least one embodiment.

The current measurement circuit 104 includes a resistor 401, the current measurement terminal 115, the reference terminal 116, and the signal output terminal 117. The output current of the voltage control circuit 103 received at the current measurement terminal 115 flows to the reference terminal 116 through the resistor 401. Because of this, a voltage corresponding to the current received at the current measurement terminal 115 is provided from the signal output terminal 117.

The output current of the voltage control circuit 103 received at the current measurement terminal 115 is a direct current, and the magnitude of the current becomes larger as the generated power of the power generation element 102 becomes higher. It is preferred that the signal output terminal 117 be connected to an external device through use of a cable. The voltage provided from the signal output terminal 117 is provided to the external device through the cable as the measurement signal. The current measurement circuit 104 is suitably used for providing the measurement result of the power generation characteristic by wire. The external device analyzes the environment in which the power generation element 102 is placed through use of the read measurement signal.

Next, modification examples of the voltage control circuit and the current measurement circuit in the environment sensor according to the at least one embodiment are each described. Herein, the voltage control circuit and the current measurement circuit in the modification examples are referred to as "voltage control circuit 103a" and "current measurement circuit 104a," respectively.

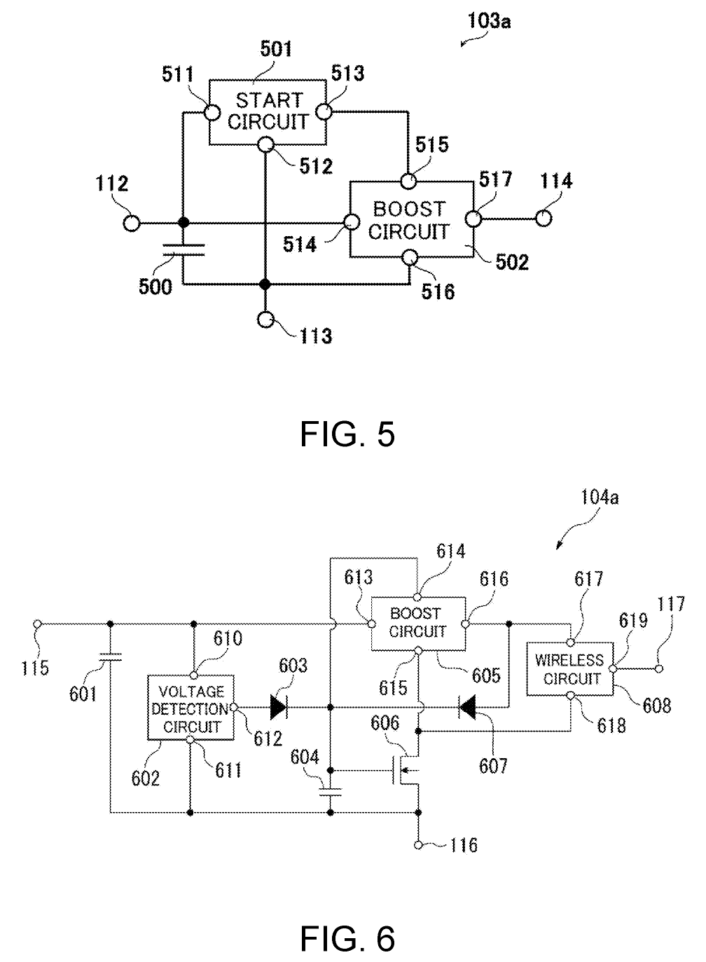

FIG. 5 is a diagram for illustrating a configuration example (second configuration example) of the voltage control circuit 103a which is a modification example of the voltage control circuit in the environment sensor according to the at least one embodiment.

The voltage control circuit 103a includes a capacitor 500, a start circuit 501, a boost circuit 502, the voltage control terminal 112, the reference terminal 113, and the current output terminal 114.

The start circuit 501 includes an input terminal 511, a reference terminal 512, and a start voltage output terminal 513. The boost circuit 502 includes an input terminal 514, a power supply terminal 515, a reference terminal 516, and a boosted power output terminal 517. The capacitor 500 includes a first end (lower side in FIG. 5) and a second end (upper side in FIG. 5).

The second end of the capacitor 500 and the input terminal 514 of the boost circuit 502 are connected to a connection point between the input terminal 511 of the start circuit 501 and the voltage control terminal 112. The first end of the capacitor 500 and the reference terminal 516 are connected to a connection point between the reference terminal 512 and the reference terminal 113. The start voltage output terminal 513 is connected to the power supply terminal 515. The boosted power output terminal 517 is connected to the current output terminal 114.

The start circuit 501 supplies boosted power obtained by boosting the voltage of the voltage control terminal 112 to the power supply terminal 515 of the boost circuit 502 when the voltage of the voltage control terminal 112 becomes equal to or higher than a first predetermined voltage. The start circuit 501 operates the boost circuit 502 for a predetermined time by supplying the boosted power to the boost circuit 502. When the boost circuit 502 starts its operation, the boost circuit 502 provides the output current obtained by boosting the electric power accumulated in the capacitor 500, that is, the stored power from the current output terminal 114.

FIG. 6 is a diagram for illustrating a configuration example (second configuration example) of the current measurement circuit 104a which is a modification example of the current measurement circuit in the environment sensor according to the at least one embodiment.

The current measurement circuit 104a includes a capacitor 601, a voltage detection circuit 602, a diode 603, a capacitor 604, a boost circuit 605, an NMOS transistor 606, a diode 607, and a wireless circuit 608. The capacitor 601 and the capacitor 604 each include a first end (lower side in FIG. 6) and a second end (upper side in FIG. 6).

The voltage detection circuit 602 includes a voltage detection terminal 610, a reference terminal 611, and a detection output terminal 612. The boost circuit 605 includes an input terminal 613, a power supply terminal 614, a reference terminal 615, and a boosted power output terminal 616. The wireless circuit 608 includes a power supply terminal 617, a reference terminal 618, and a wireless signal output terminal 619.

The current measurement terminal 115 is connected to the second end of the capacitor 601, the voltage detection terminal 610, and the input terminal 613.

The detection output terminal 612 is connected to an anode of the diode 603 serving as a rectifying element. A cathode of the diode 603 is connected to the power supply terminal 614, a cathode of the diode 607 serving as a rectifying element, a gate of the NMOS transistor 606, and the second end of the capacitor 604.

The wireless signal output terminal 619 is connected to the signal output terminal 117. The boosted power output terminal 616 is connected to an anode of the diode 607 and the power supply terminal 617. The reference terminal 615 and the reference terminal 618 are connected to a drain of the NMOS transistor 606.

The first end of the capacitor 601, the reference terminal 611, the first end of the capacitor 604, and a source of the NMOS transistor 606 are each connected to the reference terminal 116.

The current received from the current measurement terminal 115 charges the capacitor 601. The voltage detection circuit 602 detects the stored voltage of the capacitor 601 by the voltage detection terminal 610 connected to the capacitor 601. When the voltage detection circuit 602 detects that the stored voltage of the capacitor 601 has become equal to or higher than a second predetermined voltage, the voltage detection circuit 602 supplies the stored power of the capacitor 601 to each of the power supply terminal 614 and the gate of the NMOS transistor 606. Here, the voltage detection circuit 602 supplies the stored power from the detection output terminal 612 through the diode 603 to each of the power supply terminal 614 and the gate of the NMOS transistor 606.

When the NMOS transistor 606 is turned on by the stored voltage of the capacitor 601, the boost circuit 605 boosts the stored power of the capacitor 601 by the stored power of the capacitor 601 received from the input terminal 613. When the boost circuit 605 starts a boosting operation, the boost circuit 605 provides the boosted power obtained by boosting the stored power of the capacitor 601 from the boosted power output terminal 616. The boosted power is supplied to the gate of the NMOS transistor 606 through the diode 607.

Here, the boosted power supplied to the gate of the NMOS transistor 606 is not supplied to the detection output terminal 612 of the voltage detection circuit 602 owing to the diode 603. Because of this, even when the stored voltage of the capacitor 601 decreases owing to the operation of the boost circuit 605 and the voltage detection circuit 602 transitions from a detection state to a non-detection state, that is, cancels the detection state, the ON state of the NMOS transistor 606 is maintained, and the driving of the wireless circuit 608 is maintained.

When the wireless circuit 608 is driven, the wireless circuit 608 provides a wireless signal from the wireless signal output terminal 619. Through operation of the boost circuit 605, the stored power of the capacitor 601 is consumed. Thus, the stored voltage of the capacitor 601 decreases. When the stored voltage of the capacitor 601 decreases to a very low voltage, the boost circuit 605 can no longer provide the boosted power, and the wireless circuit 608 stops its operation. Further, when the boosted power is not provided from the boost circuit 605, the gate voltage of the NMOS transistor 606 decreases. Thus, the NMOS transistor 606 is turned off. When the NMOS transistor 606 is turned off, the charging of the capacitor 601 is restarted. When the stored voltage of the capacitor 601 for which the charging is restarted reaches the second predetermined voltage again, the wireless circuit 608 operates again by receiving the supply of the boosted power from the boost circuit 605 as described above. In this manner, the wireless circuit 608 operates intermittently to generate an intermittent wireless signal. Accordingly, the wireless signal provided from the wireless circuit 608 becomes an intermittent pulse.

As described above, the wireless signal is provided from the wireless circuit 608 to the external device through use of the stored power accumulated in the capacitor 601 by the current received from the current measurement terminal 115. As the power generation characteristic of the power generation element 102 becomes higher, the speed at which electric power is accumulated in the capacitor 601 by the current received from the current measurement terminal 115 becomes faster. Accordingly, as the frequency of the wireless signal provided from the wireless circuit 608 becomes higher (the interval of the intermittent pulse becomes narrower), the power generation characteristic of the power generation element 102 becomes higher. The current measurement circuit 104a (FIG. 6) is suitably used for providing the measurement result of the power generation characteristic as a wireless signal.

The capacitor 604 is provided to maintain the gate voltage of the NMOS transistor 606 until the boost circuit 605 which has started its operation becomes able to provide the boosted power, and to maintain the operation of the boost circuit 605 and the wireless circuit 608.

As described above, the environment sensor 101 and the environment power generation device 10, which is each example of the environment sensor and the environment power generation device according to the at least one embodiment can control the voltage of the positive electrode terminal 111 of the power generation element 102 connected to the voltage control terminal 112 to the first predetermined voltage. Accordingly, there is no need to wait until the voltage of the positive electrode terminal 111 reaches a drop voltage value corresponding to the power generation characteristic, unlike the related art, and the power generation characteristic of the power generation element can be measured so as to follow the environment that changes moment by moment. Further, the environment sensor according to the at least one embodiment can provide the measurement result as the measurement signal to the external device. Because of this, the external device can perform highly accurate analysis that follows the environment that changes moment by moment.

The at least one embodiment of the present invention has been described above with reference to the drawings, but the specific configurations are not limited to the configurations described above. In the implementation stage, it is possible to carry out the present invention in various forms in addition to the examples described above, and various omissions, replacements, or changes are possible without departing from the gist of the invention.

For example, the biofuel cell illustrated in FIG. 2 is an example in which the negative electrode 202 includes the mediator 206, but the biofuel cell may include the negative electrode 202 from which the mediator 206 is omitted. In addition, in the biofuel cell illustrated in FIG. 2, the area of the positive electrode 203 is formed to be larger than the area of the negative electrode 202, but the area of the positive electrode 203 is not necessarily required to be formed to be larger than the area of the negative electrode 202. That is, the area of the positive electrode 203 may be formed to be equal to or smaller than the area of the negative electrode 202. However, as described above, in order to increase the change in the power generation characteristic with respect to the change in the fuel concentration and further improve the measurement accuracy of the fuel concentration, it is preferred that any one of the negative electrode 202 including the mediator 206 or the area of the positive electrode 203 being larger than the area of the negative electrode 202 be satisfied, and it is further preferred that both be satisfied.

Further, the power generation element 102 has been described by taking the biofuel cell as an example, but the power generation element 102 may be a fuel cell of a type other than the biofuel cell. Further, the power generation element 102 may be any element as long as the element generates electric power (performs power generation) in accordance with its environment.

In the above-mentioned environment sensor 101 and environment power generation device 10, the environment sensor 101 is not limited to the example including the voltage control circuit 103 (FIG. 3) and the current measurement circuit 104 (FIG. 4). The environment sensor 101 may include any one of the voltage control circuit 103 or the voltage control circuit 103a (FIG. 5), and may include any one of the current measurement circuit 104 or the current measurement circuit 104a (FIG. 6). That is, the environment sensor 101 may adopt a configuration including the voltage control circuit 103 and the current measurement circuit 104a, a configuration including the voltage control circuit 103a and the current measurement circuit 104a, or a configuration including the voltage control circuit 103a and the current measurement circuit 104.

The diode 603 and the diode 607 are not limited to diode elements. Any element that has a rectifying function, that is, a rectifying element, is acceptable regardless of its type. For example, a so-called diode-connected FET in which the drain and the gate are connected to each other has a function similar to that of a diode, that is, a rectifying function. Thus, the diode-connected FET is included in the rectifying element in the at least one embodiment.

These embodiments and modifications thereof are included in the scope and spirit of the invention, and are included within the scope of the invention described in the claims and equivalents thereof.

What is claimed is:

1. An environment sensor, comprising:
a voltage control circuit including a voltage control terminal configured to receive a generated current generated by a power generation element and a current output terminal configured to provide an output current corresponding to the generated current, the voltage control circuit being configured to receive the generated current at the voltage control terminal while controlling a voltage of a positive electrode terminal of the power generation element connected to the voltage control terminal to a first predetermined voltage lower than a generated voltage of the power generation element; and
a current measurement circuit including a current measurement terminal configured to receive the output current provided from the voltage control circuit and a signal output terminal configured to provide a measurement signal corresponding to the output current received at the current measurement terminal.

2. The environment sensor according to claim 1,
wherein the current measurement circuit includes a capacitor configured to accumulate electric power by the output current received from the current measurement terminal, and
wherein the signal output terminal is configured to provide an intermittent pulse as the measurement signal through use of the electric power accumulated in the capacitor.

3. The environment sensor according to claim 2,
wherein the current measurement circuit includes a voltage detection circuit configured to detect a stored voltage of the capacitor, a boost circuit configured to provide boosted power obtained by boosting stored power of the capacitor, and a rectifying element, and
wherein, when the voltage detection circuit detects that the stored voltage of the capacitor is equal to or higher than a second predetermined voltage, the boost circuit is configured to start up with the stored power of the capacitor supplied through the rectifying element, and, with an operation of the boost circuit being maintained by the boosted power, generate the measurement signal by the boosted power and provide the measurement signal from the signal output terminal.

4. The environment sensor according to claim 1, wherein the output current received at the current measurement terminal of the current measurement circuit is a direct current, and the current measurement circuit is configured to provide a voltage corresponding to the direct current from the signal output terminal as the measurement signal.

5. The environment sensor according to claim 1, wherein the power generation element is a biofuel cell including a negative electrode including a mediator, and a positive electrode connected to the voltage control terminal.

6. The environment sensor according to claim 1,
wherein the power generation element is a biofuel cell including a negative electrode and a positive electrode connected to the voltage control terminal, and
wherein the positive electrode is formed to have an area larger than an area of the negative electrode.

7. An environment power generation device, comprising:
a power generation element;
a voltage control circuit including a voltage control terminal configured to receive a generated current generated by the power generation element and a current output terminal configured to provide an output current corresponding to the generated current, the voltage control circuit being configured to receive the generated current at the voltage control terminal while controlling a voltage of a positive electrode terminal of the power generation element connected to the voltage control terminal to a first predetermined voltage lower than a generated voltage of the power generation element; and
a current measurement circuit including a current measurement terminal configured to receive the output current provided from the voltage control circuit and a signal output terminal configured to provide a measurement signal corresponding to the output current received at the current measurement terminal.

8. The environment power generation device according to claim 7, wherein the power generation element is a biofuel cell including a negative electrode including a mediator, and a positive electrode connected to the voltage control terminal.

9. The environment power generation device according to claim 7,
wherein the power generation element is a biofuel cell including a negative electrode and a positive electrode connected to the voltage control terminal, and
wherein the positive electrode is formed to have an area larger than an area of the negative electrode.
